(19) United States
(12) Patent Application Publication
(10) Pub. No.: US 2018/0358611 A1
(43) Pub. Date: Dec. 13, 2018

(54) SECONDARY CELL

(71) Applicant: HITACHI AUTOMOTIVE SYSTEMS, LTD., Hitachinaka-shi, Ibaraki (JP)

(72) Inventors: Naoki KIMURA, Tokyo (JP); Eiji SEKI, Tokyo (JP)

(73) Assignee: HITACHI AUTOMOTIVE SYSTEMS, LTD., Hitachinaka-shi, Ibaraki (JP)

(21) Appl. No.: 15/781,521

(22) PCT Filed: Dec. 2, 2016
(86) PCT No.: PCT/JP2016/085837

§ 371 Date: Jun. 5, 2018

(30) Foreign Application Priority Data
Dec. 10, 2015 (JP) 2015-241135

(51) Int. Cl. H01M 4/36; H01M 10/0525; H01M 10/0566; H01M 10/0585; H01M 4/505; H01M 4/525; H01M 2/30; H01M 4/04

(52) U.S. Cl. CPC H01M 4/364; H01M 10/0525; H01M 10/0566; H01M 4/0402; H01M 4/505; H01M 4/525; H01M 2/30; H01M 10/0585

(57) ABSTRACT

Provided is a secondary cell excellent in cycle characteristics. The secondary cell includes a positive electrode 5, a negative electrode 6, and an electrolytic solution. A positive electrode mixture of the positive electrode 5 contains LiOH, LiₐNi_{b}Co_{c}A_{d}BₑO₂ which is a positive electrode active material (a, b, c, d, and e satisfy 1.0≤a≤1.1, 0.45≤b≤0.90, 0.05≤c+d≤0.55, and 0≤e≤0.006, “A” contains at least one of Mn and Al, and “B” contains at least one of Al, Mg, Mo, Ti, W and Zr), and an oxide. The oxide contains at least one of aluminum oxide, magnesium oxide, molybdenum oxide, titanium oxide, tungsten oxide, and zirconium oxide.

### TECHNICAL FIELD

The present invention relates to a secondary cell.

### BACKGROUND ART

In recent years, due to the problems of global warming and fossil fuel depletion, electric vehicles (EV) with low energy consumption are being developed by automobile manufacturers. As a power source of an electric vehicle, a lithium ion secondary cell having a high energy density is required. However, at the present time, a lithium ion secondary cell having a sufficient energy density has not been obtained.

Ni-based positive electrode active material such as LiNiₓCo_{y}MzO₂ (M is such as Mn and Al, and x>y and z) is expected as a positive electrode active material for realizing a high energy density lithium ion secondary cell. However, it is known that there is a problem in cycle characteristics of the Ni-based positive electrode active material.

One of the factors deteriorating the cycle characteristics is the influence of alkali component remaining at the time of synthesis. PTL 1 reports that the cycle characteristics are improved by removing alkali component by washing active material with water and suppressing destruction of the crystal structure of a surface by synthesizing Ni-based positive electrode active material with an accurate Li composition.

### CITATION LIST

### Patent Literature

PTL 1: JP H08-138669 A

### SUMMARY OF INVENTION

### Technical Problem

However, according to the method described in PTL 1, cost increase due to washing with water is a problem, and it is considered to be difficult to put into practical use.

### Solution to Problem

According to a first embodiment of the secondary cell according to the present invention, the secondary cell includes a positive electrode, a negative electrode, and an electrolytic solution. A positive electrode mixture of the positive electrode contains LiOH, LiₐNi_{b}Co_{c}A_{d}BₑO₂ which is a positive electrode active material (a, b, c, d, and e satisfy 1.0≤a≤1.1, 0.45≤b≤0.90, 0.05≤c+d≤0.55, and 0≤e≤0.006, A contains at least one of Mn and Al, and B contains at least one of Al, Mg, Mo, Ti, W, and Zr), and an oxide. The oxide contains at least one of aluminum oxide, magnesium oxide, molybdenum oxide, titanium oxide, tungsten oxide, and zirconium oxide.

### Advantageous Effects of Invention

According to the present invention, a secondary cell excellent in cycle characteristics can be provided.

### BRIEF DESCRIPTION OF DRAWINGS

FIG. 1 is an exploded perspective view illustrating an example of a secondary cell.

FIG. 2 is an exploded perspective view illustrating a laminate structure of a laminated electrode group.

FIG. 3 indicates the composition of a positive electrode active material, coating state, and the amount of LiOH in Examples 1 to 36 in the case of forming a coating of an oxide.

FIG. 4 is a diagram indicating Comparative Examples 1 to 24 with respect to Examples 1 to 36.

FIG. 5 is a view indicating other Comparative Examples 25 to 66 with respect to Examples 1 to 36.

FIG. 6 is a diagram indicating measurement results of the initial capacity, the initial DC resistance, and the DC resistance increase rate at 200 cycles in Examples 1 to 36.

FIG. 7 is a diagram indicating measurement results of Comparative Examples 1 to 24.

FIG. 8 is a diagram indicating measurement results of Comparative Examples 25 to 66.

FIG. 9 is a diagram indicating high voltage cycle test results.

### DESCRIPTION OF EMBODIMENTS

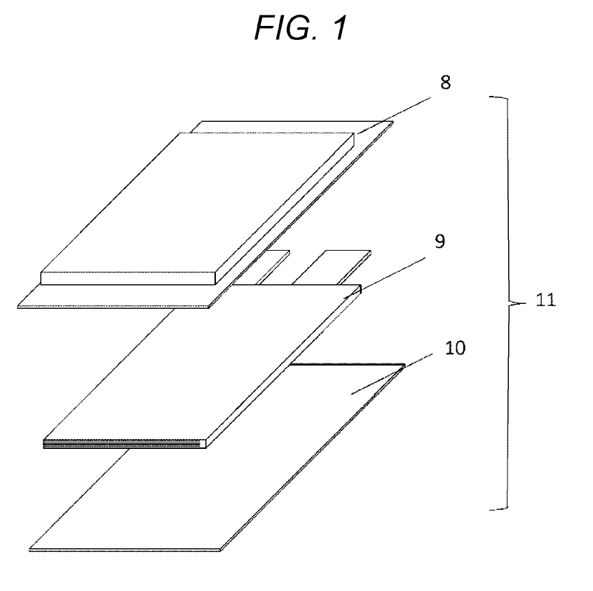

An embodiment of the present invention will be described below with reference to drawings. First, the schematic configuration of a secondary cell will be described. FIG. 1 is an exploded perspective view of a laminate type lithium ion secondary cell (hereinafter referred to as a “laminate cell”) and indicates an example of the secondary cell. In the following description, a stacked laminate cell will be described as an example. However, similarly the present invention can be applied even to a secondary cell having another configuration, for example, a secondary cell having a wound structure or enclosed in a metal can.

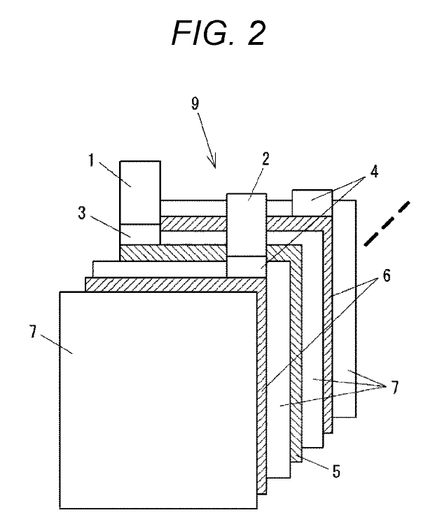

As illustrated in FIG. 1, a laminate cell 11 is obtained by enclosing a laminated electrode group 9 and electrolytic solution in laminate films 8 and 10. FIG. 2 is an exploded perspective view illustrating a laminate structure of the laminated electrode group 9. In the laminated electrode group 9, a plate-like positive electrode 5 and a strip-shaped negative electrode 6 are laminated via a separator 7. In the positive electrode 5, a positive electrode mixture layer is formed on front and rear surfaces of a positive electrode current collector plate. A part of the positive electrode current collector plate is a positive electrode uncoated portion 3 on which a positive electrode mixture layer is not formed. The negative electrode 6 is formed by forming a negative electrode mixture layer on both front and back surfaces of a negative electrode current collector plate. A part of the negative electrode current collector plate is formed as a negative electrode uncoated portion 4 on which the negative electrode mixture layer is not formed. Note that a metal foil is used for the positive electrode current collector plate and the negative electrode current collector plate.

The positive electrode uncoated portion 3 of each positive electrode 5 is bundled and ultrasonically welded to a positive electrode terminal 1. Similarly, the negative electrode uncoated portion 4 of each negative electrode 6 is bundled and ultrasonically welded to the negative electrode terminal 2. Other welding methods such as resistance welding may be used.

Note that, to further certainly seal the inside and outside of the cell in the positive electrode terminal 1 and the negative electrode terminal 2, heat sealing resin is coated on or attached to a sealing portion of the terminals in advance.

Next, characteristics of the secondary cell according to the present embodiment will be described. As described above, it is known that there is a problem in the cycle characteristics of a Ni-based positive electrode active material. However, the inventor of the present invention has earnestly studied and found that the following cycle DCR increase mechanism is the main factor of deteriorating the cycle characteristics.

LiOH and HF react with each other as in “LiOH+HF→H₂O+LiF” in a positive electrode mixture having a large amount of LiOH, whereby H₂O is likely to be generated. Furthermore, when H₂O is present, in the case of an electrolyte having such as LiPF₆ and LiBF₄, H₂O reacts with LiPF₆ and LiBF₄ to generate HF. These reactions loop to increase HF. HF reacts with a high-nickel positive electrode active material to break the crystal structure of a surface of a positive electrode active material to form an inactive NiO layer or a solid electrolyte interphase (SEI) coating such as LiF. It has been considered that the increase in the NiO layer and the increase in the SEI coating layer lead to a significant increase in cycle DCR. It is known that in the case where the amount of LiOH is small due to washing with water, the increase in cycle DCR hardly occurs as disclosed in PTL 1.

In the present embodiment, to suppress formation of the NiO layer and the SEI coating layer indicated in the above study, a coating layer of an oxide which reacts with HF is formed on a surface of the positive electrode active material. Accordingly, the increase in cycle DCR is suppressed. For example, when aluminum oxide (Al₂O₃) is formed as an oxide, the formation of the NiO layer and the SEI coating layer is suppressed by reaction of aluminum oxide and HF as “Al₂O₃+HF→2AlF.H₂O”. Incidentally, the coating amount of the oxide is preferably set to such an extent that initial resistance is not increased. As the oxide, such as aluminum oxide, magnesium oxide, molybdenum oxide, titanium oxide, tungsten oxide, and zirconium oxide can be used.

That is, the secondary cell according to the present embodiment includes a positive electrode, a negative electrode, and an electrolytic solution. A positive electrode mixture of the positive electrode contains LiOH, LiₐNi_{b}Co_{c}A_{d}BₑO₂ which is a positive electrode active material (a, b, c, d, and e satisfy 1.0≤a≤1.1, 0.45≤b≤0.90, 0.05≤c+d≤0.55, and 0≤e≤0.006, “A” contains at least one of Mn and Al, and “B” contains at least one of Al, Mg, Mo, Ti, W and Zr), and an oxide. The oxide contains at least one of aluminum oxide, magnesium oxide, molybdenum oxide, titanium oxide, tungsten oxide, and zirconium oxide.

Next, a manufacturing procedure of the secondary cell according to the present embodiment will be described.

<Preparation of Positive Electrode Active Material>

As described above, the positive electrode active material used in the secondary cell according to the present embodiment is represented by the general formula: LiₐNi_{b}Co_{c}A_{d}BₑO₂. As a raw material of the positive electrode active material, in addition to nickel oxide and cobalt oxide, manganese dioxide, aluminum oxide, magnesium oxide, molybdenum oxide, tungsten oxide, titanium oxide, and zirconium oxide are appropriately used depending on which element is used among the above-described elements in the general formulas A and B.

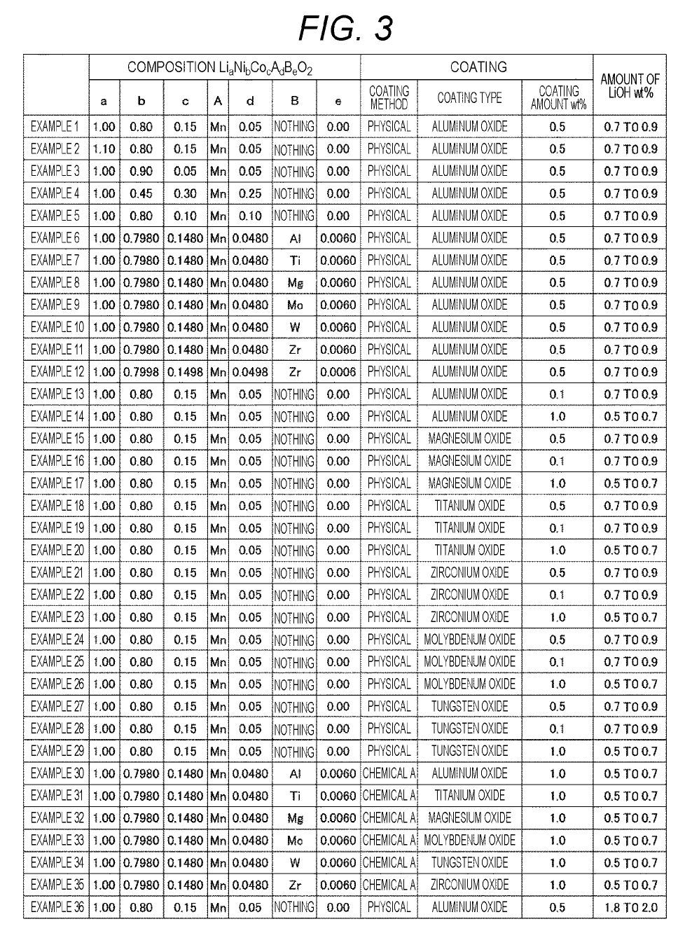

FIG. 3 indicates the composition of a positive electrode active material, coating state, and the amount of LiOH in Examples 1 to 36 in the case of forming a coating of an oxide. The kinds of oxides to be coated are aluminum oxide in Examples 1 to 14, 30 and 36, magnesium oxide in Examples 15 to 17, and 32, titanium oxide in Examples 18 to 20, and 31, zirconium oxide in Examples 21 to 23, and 35, molybdenum oxide in Examples 24 to 26, and 33, and tungsten oxide in Examples 27 to 29, and 34. These raw materials are weighed so as to have a predetermined atomic ratio (b, c, d, and e indicated in FIG. 3), and then pure water is added to form a slurry. In this way, when the positive electrode active material is prepared, a positive electrode active material having different composition is prepared by changing a mixing ratio of each raw material.

These oxides are desirably in the range of 0.1 nm or more and 100 nm or less, and the average particle diameter is desirably about 10 nm to 50 nm. The smaller the particle diameter is, the lower the initial DC resistance becomes. However, this range is desirable in consideration of handleability during coating operation. The coating thickness of the oxide is preferably about 1 particle, specifically, 0.1 nm or more and 100 nm or less, and the average thickness is preferably about 10 nm to 50 nm. These ranges are also due to the above reasons.

In FIG. 3, although “B” is described as being equally substituted for other transition metals, it is obscure since “B” is a very small amount, and the description is as a hypothesis.

In the present embodiment, as a coating method, a physical method (Examples 1 to 29, and 36) to be described later, a method called as Chemical A (Examples 30 to 35), a method called Chemical B (Comparative Example 23) are used. In the method referred to as Chemical A, when preparing the above-described slurry, the amount of the oxide to be coated is further increased by 1 wt % (wt % based on the weight of the positive electrode active material). For example, in Example 30 in which aluminum oxide is coated by the method of Chemical A, aluminum oxide is excessively added by 1 wt % when the slurry is prepared. Chemical B will be described later.

Next, the slurry is pulverized with a bead mill until the average particle diameter becomes 0.2 μm. Thereafter, 1 wt % of polyvinyl alcohol (PVA) solution is added to the slurry in terms of a solid content ratio, mixed for an additional one hour, and granulated and dried by a spray dryer.

Then, such that the ratio of Li:(NiCoAB) becomes 1.0 (Examples 1 and 3 to 36) or 1.1 (Example 2), lithium hydroxide and lithium carbonate of the amount of 1.0 wt % or more and less than 1.15 wt % is added to the granulated particles to adjust the amount of Li.

Next, this powder is fired at 850° C. for ten hours to have a layered structure crystal and then disintegrated to obtain a positive electrode active material. Further, coarse particles having a particle size of 30 μm or more are removed by classification. The positive electrode active material thus obtained having a particle diameter of less than 30 μm is used for electrode preparation.

The method of preparing the positive electrode active material according to the present example is not limited to the above method, and other methods such as a coprecipitation method may be used.

Further, with respect to Examples 1 to 29 and 36, oxides are mechanically coated on the prepared positive electrode active material by a mechanochemical method. In the present embodiment, this coating method will be referred to as a “physical coating method”. In the present embodiment, NOBILTA (registered trademark) made by Hosokawa Micron is used for oxide coating by the mechanochemical method. However, such as a ball mill, a mechano-fusion device may be used.

In FIG. 3, the amount of LiOH is a value measured by a neutralization titration method. Specifically, 0.5 g of the active material is weighed, 30 ml of pure water is added, shaking is carried out for 30 minutes, and supernatant liquid after centrifugation is filtered with a membrane filter (0.45 μm) to obtain a filtrate. The filtrate after extraction is titrated with hydrochloric acid, and the amount of LiOH is calculated. Titration occurs in the order of (1), (2), and (3) below.

LiOH+HCl→LiCl+H₂O (1)

Li₂CO₃+HCl→LiCl+LiHCO₃ (2)

LiHCO₃+HCl→LiClO+H₂CO₃ (3)

LiOH (mol) and LiOH (g) are calculated according to the formulas (4) and (5) and substituted into the formula (6) to calculate LiOH (wt %).

LiOH (mol)=hydrochloric acid concentration (mol)×((titration amount (1) of ((1)+(2))×2−titration amount (1) up to (3)) (4)

LiOH (g)=LiOH (mol)×LiOH molecular weight 23.95 (g/mol) (4)

LiOH (wt %)=LiOH (g)×active material amount 0.5 g (filtrate recovery amount (1) pure water (1))×100 (6)

Note that, as LiOH in the active material, in addition to LiOH remaining as a residue at the time of synthesis, LiOH is generated when stored in the atmosphere. During the storage in the atmosphere, the reaction of formula (7) occurs, and LiOH is generated. In Example 36 indicated in FIG. 3, the atmosphere is opened for about half a year, and the LiOH amount is relatively high due to the influence of the reaction of formula (7). In addition, except for Example 36, after synthesis, argon is sealed, and measured and used within several weeks after opening.

(Li ion in active material)+residual H₂O+O₂→LiOH.H₂O (7)

Further, although the amount of LiOH after coating tends to be low, this is due to reducing the amount at titration by the effect of coating, and the actual amount of LiOH is presumed to be the same as before the coating.

<Preparation of Positive Electrode>

The positive electrode is one in which a coating layer of a positive electrode active material mixture containing a positive electrode active material is formed on both surfaces of an aluminum foil as a positive electrode current collector. In the coating layer of the positive electrode active material mixture, a positive electrode active material mixture in which a positive electrode active material, a binder, and a conductive auxiliary agent are dispersed in a solvent is coated on the surface of a positive electrode current collector. Polyvinylidene fluoride (hereinafter referred to as “PVDF”) is used as a binder, and a carbon material is used as a conductive aid. The mass ratio of the positive electrode active material, the binder, and the conductive material is set to 90:5:5. As a solvent, N-methylpyrrolidone (hereinafter abbreviated as “NMP”) is used, and the viscosity is adjusted according to the amount. The coating amount of the positive electrode active material mixture to the positive electrode current collector is set to 240 g/m².

The positive electrode current collector coated with the positive electrode active material mixture agent is, after the coating layer of the positive electrode active material mixture has been dried, rolled and pressed by a roll press machine such that the density of the positive electrode active material mixture layer is 3.0 g/cm³. As described above, the positive electrode illustrated in FIG. 2 is prepared by the process. In the positive electrode 5 illustrated in FIG. 2, the positive electrode uncoated portion 3 not coated with the positive electrode active material mixture is formed on a part of the positive electrode current collector, and the aluminum foil is exposed in this portion.

<Preparation of Negative Electrode Active Material and Negative Electrode>

Various negative electrode active materials are used in the secondary cell according to the present invention. However, natural graphite is used in the present embodiment. Instead of natural graphite, as a negative electrode active material, a material that can reversibly occlude and release lithium ions, such as a carbon material such as artificial graphite and amorphous carbon, Si oxide, an alloy of Si or Sn is used. In addition, a mixture of these may be used.

For the negative electrode active material mixture, in addition to the negative electrode active material, acetylene black is used as a conductive material, styrene butadiene rubber (SBR) is used as a binder, and carboxymethyl cellulose (CMC) is used as a thickener. The weight ratio of them is 98:1:1 in order. Further, the coating amount of the negative electrode is adjusted such that the volume ratio became 1.1. At the time of coating the negative electrode active material mixture on a copper foil, the viscosity is adjusted with a water solvent. At this time, as illustrated in FIG. 2, a negative electrode uncoated portion 4 not coated with the negative electrode active material mixture is formed on a part of the copper foil. In the negative electrode uncoated portion 4, the copper foil is exposed. The density of the negative electrode 6 is adjusted by a roll press after drying, and in the present embodiment, the density is prepared at a density of 1.5 g/cm³.

<Preparation of Secondary Cell>

A procedure for manufacturing a secondary cell using the positive electrode and the negative electrode prepared by the above-described processes will be described. First, as illustrated in FIG. 2, a laminated electrode group 9 is formed by using a plurality of positive electrodes 5 and a plurality of negative electrodes 6. Between the positive electrode 5 and the negative electrode 6, a separator 7 is provided.

The material used for the separator 7 may be any material as long as it blocks movement of lithium ions by heat shrinkage when the secondary cell generates heat for some reason.

For example, polyolefin can be used. Polyolefin is a chain polymer material typified by polyethylene or polypropylene. The separator 7 of the present embodiment is a composite material of polyethylene and polypropylene.

As the separator 7, a polyolefin containing a heat-resistant resin such as polyamide, polyamideimide, polyimide, polysulfone, polyethersulfone, polyphenylsulfone, and polyacrylonitrile can be used.

Further, an inorganic filler layer may be formed on one side or both sides of the separator 7. The inorganic filler layer is composed of a material containing at least one of SiO₂, Al₂O₃, montmorillonite, mica, ZnO, TiO₂, BaTiO₃, and ZrO₂, for example. From the viewpoint of cost and performance, SiO₂ or Al₂O₃ is preferable.

The positive electrode uncoated portion 3 of each positive electrode 5 is bundled and ultrasonically welded to a positive electrode terminal 1. Similarly, the negative electrode uncoated portion 4 of each negative electrode 6 is bundled and ultrasonically welded to the negative electrode terminal 2. As a result, an integrated laminated electrode group 9 is formed. Then, as illustrated in FIG. 1, by laminating the laminated electrode group 9 and the electrolytic solution in the laminate films 8 and 10, the laminate cell 11 is formed.

First, after sandwiching the laminated electrode group 9 with the laminate films 8 and 10, the laminate films 8 and 10 are brought into contact with each other at the peripheral edge portions thereof and sealed by heat sealing at 175° C. for 10 seconds. At that time, to provide an injection port for pouring an electrolytic solution into the laminate cell, three sides excluding one side serving as an injection port are heat-sealed. Then, after pouring the electrolytic solution into the laminate cell from the injection port, the side is sealed by thermal sealing while vacuum-pressurizing.

Note that one side as the injection port is adjusted such that the heat sealing strength becomes weaker than that of the other three sides. This is to have the effect of a gas discharge valve when gas is generated in the laminate cell with charging and discharging. As a unit for discharging the gas, in addition to the above, it is also possible to provide a thin portion in a part of the laminate film 8 such that the gas is discharged from the thin portion.

An organic electrolytic solution is used as the electrolytic solution. This organic electrolytic solution is obtained by dissolving 1 mol/dm⁻³ of LiPF₆ as an electrolyte in an organic solvent of ethylene carbonate (EC): ethyl methyl carbonate (EMC)=1:3 (vol %). In addition to the above, for example, an organic electrolytic solution in which at least one type of lithium salt such as LiPF₆, LiBF₄, and LiN (C₂F₅SO₂)₂ is dissolved in a nonaqueous solvent containing at least one of such as ethylene carbonate, propylene carbonate, butylene carbonate, dimethyl carbonate, ethyl methyl carbonate, diethyl carbonate, γ-butyrolactone, γ-valerolactone, methyl acetate, ethyl acetate, methyl propionate, tetrahydrofuran, 2-methyl tetrahydrofuran, 1,2-dimethoxyethane, 1-ethoxy-2-methoxyethane, 3-methyltetrahydrofuran, 1,2-dioxane, 1,3-dioxane, 1,4-dioxane, 1,3-dioxolane, 2-methyl-1,3-dioxolane, and 4-methyl-1,3-dioxolane, can be used. Alternatively, a solid electrolyte having lithium ion conductivity, a gel electrolyte, or a known one such as a molten salt can be used. In the present embodiment, the electrolyte containing fluorine is the most effective. In particular, the effect significantly increases when LiPF₆ is used.

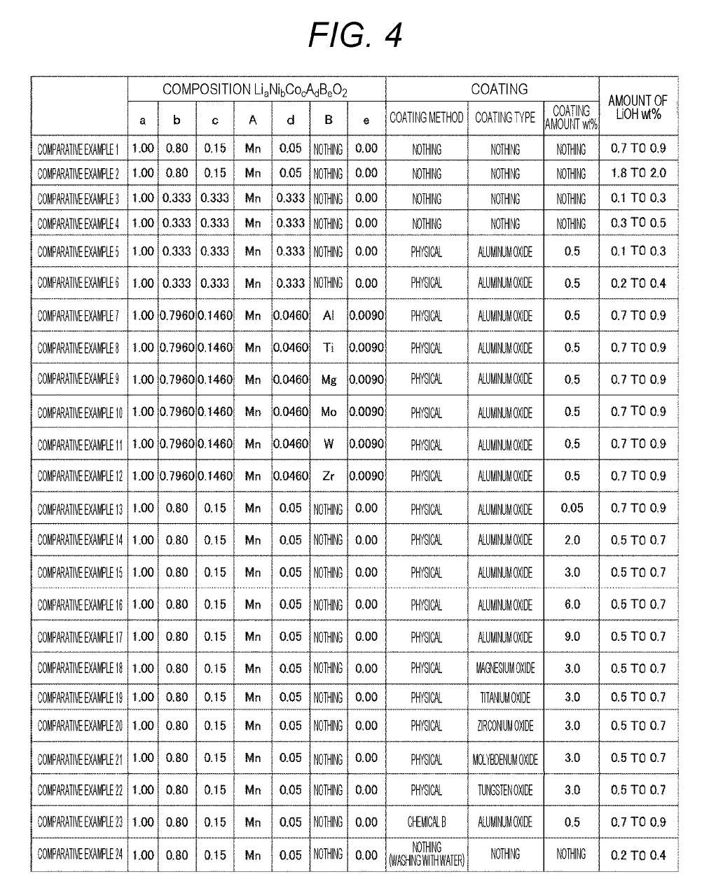

FIG. 4 indicates Comparative Examples 1 to 24 with respect to Examples 1 to 36 and indicates the composition of the positive electrode active material. In FIG. 4, Comparative Examples 1 to 4 are the cases where coating is not formed, Comparative Examples 5 to 23 are the cases where an oxide coating is formed, and Comparative Example 24 is the case where a positive electrode active material on which coating is not formed is washed with water. Comparative Example 1 is different from Example 1 in that coating is not provided, and the composition of the active material and the amount of LiOH are the same as in Example 1. In Comparative Example 2, the amount of LiOH is increased by exposing the positive electrode active material of Comparative Example 1 to the atmosphere for about six months. Similarly, in Comparative Examples 4 and 6, the amount of LiOH is increased by exposing the positive electrode active material of Comparative Examples 3 and 5 to the atmosphere for about six months. On the other hand, except for Comparative Example 24 and Comparative Examples 2, 4, and 6, after synthesis, argon sealing is carried out, and measurement and use are made within several weeks after opening.

In Comparative Examples 3 to 6, the amount of Ni is made smaller than that in the examples. In Comparative Examples 7 to 12, the amount of “e” in the element substitution B is increased. In Comparative Example 13, the coating amount is extremely small, whereas in Comparative Examples 14 to 22, the coating amount is comparatively large.

In addition, Comparative Example 23 is the case where coating is performed by a liquid phase method and coated with over 90% and 100% or less. In the present embodiment, this coating method is referred to as Chemical B. Specifically, a hydroxide of Al, Mg, Mo, W, and Zr is dispersed in a water solvent together with a positive electrode active material and heated to coat oxides of Al, Mg, Mo, W, and Zr. In Comparative Example 23, aluminum oxide is coated.

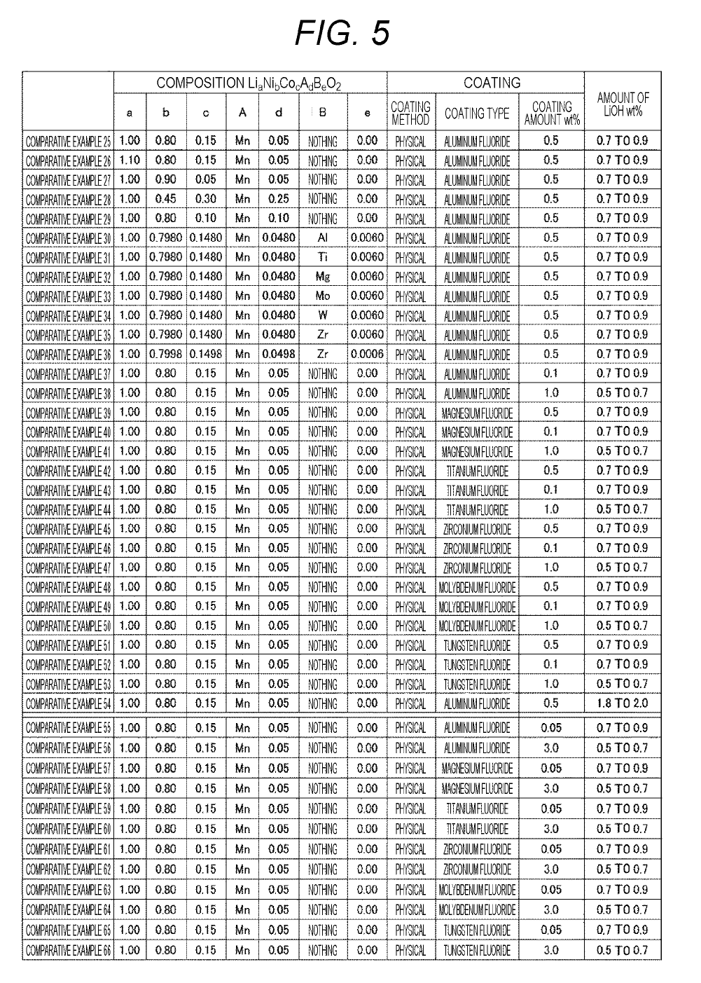

FIG. 5 is a diagram indicating other Comparative Examples 25 to 66 with respect to Examples 1 to 36.

In Comparative Examples 25 to 66, a fluoride which is an oxide which does not react with HF is used in the coating instead of the oxide which reacts with HF. In Comparative Examples 25 to 54, in the positive electrode active materials of Examples 1 to 29, and 36, the coating is replaced with fluoride from oxide. In Comparative Examples 55, 57, 59, 61, 63, and 65, the amount of fluoride in the coating is small, and in Comparative Examples 56, 58, 60, 62, 64, and 66, the amount of fluoride is large.

<Measurement of Initial Capacity, Initial DC Resistance, and DC Resistance Increase Rate During Cycle>

The above-described secondary cell (laminate cell) is charged at a constant voltage of 4.2 V and a constant current of 300 mA for five hours and then subjected to a constant current discharge with a voltage of 2.5 V and a current of 300 mA. The initial discharge capacity at this time is taken as the initial capacity of each secondary cell. Further, the initial DC resistance of the secondary cell is calculated from a quotient of voltage change ΔV and current 1 A when discharging for ten seconds at a current of 1 A from a voltage of 3.7 V after charging for five hours at a constant voltage of 3.7 V and a constant current of 300 mA.

Next, a cycle test is carried out using a cell after completion of the measurement. As charging and discharging cycle conditions, charging is performed at constant current and constant voltage with a voltage of 4.2 V and a current of 300 mA until the charge current reaches a termination condition of 6 mA, and a constant current discharge with a voltage of 3.5 V and a current of 300 mA is performed in discharge.

The cycle of charging and discharging is performed for 200 cycles. After 200 cycles, charging is performed at a constant voltage of 3.7 V and a constant current of 300 mA for five hours.

Then, discharging is performed for ten seconds at a current of 1 A from a voltage of 3.7 V, and the DC resistance at 200 cycles is calculated from a quotient of a voltage change ΔV and current 1 A at this time. The DC resistance increase rate at 200 cycles is calculated as “(initial DC resistance)÷(DC resistance at 200 cycles)×100”.

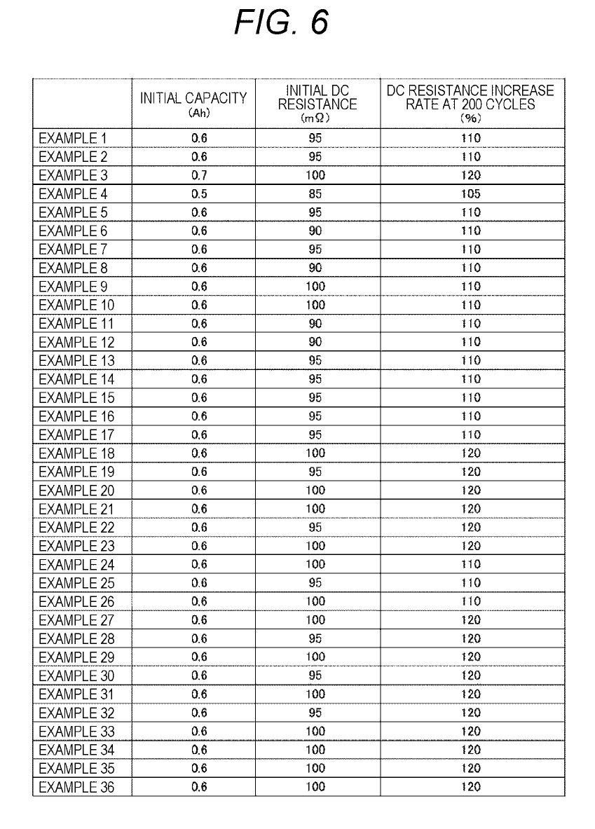

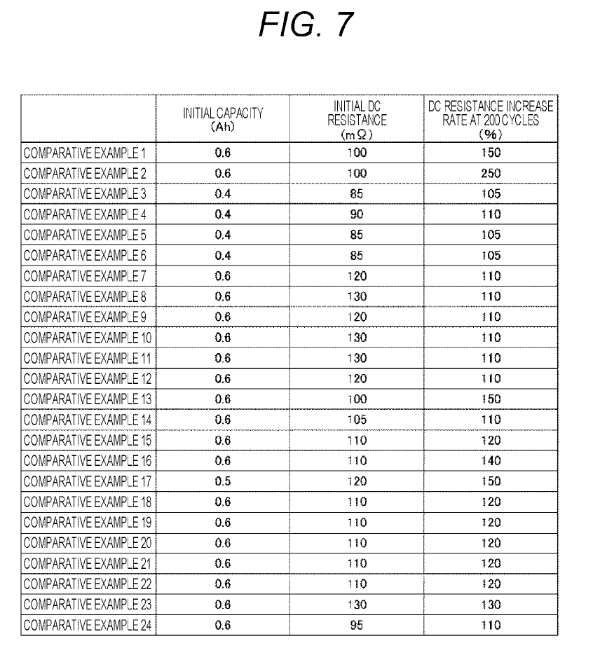

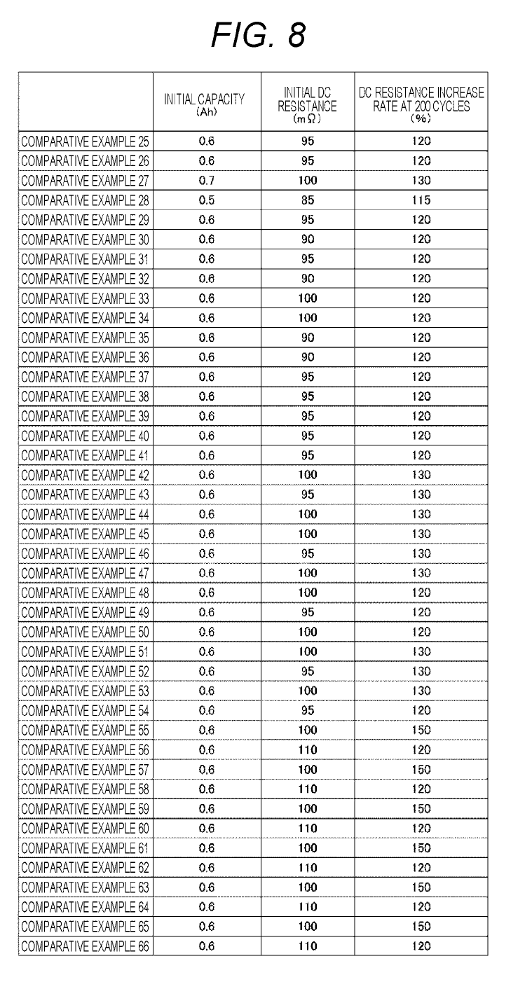

FIG. 6 indicates measurement results of the initial capacity, the initial DC resistance, and the DC resistance increase rate at 200 cycles in Examples 1 to 36. On the other hand, FIGS. 7 and 8 indicate measurement results in Comparative Examples 1 to 66. As illustrated in FIG. 6, it is seen that, in Examples 1 to 36, the initial capacity is in the range of 0.5 to 0.7 Ah, the initial DC resistance is in the range of 90 to 100 mΩ, and the DC resistance increase rate after 200 cycles is in the range of 105 to 130%.

In comparison between Example 1 and Comparative Example 1, it can be seen that performance is improved in both the initial DC resistance and the DC resistance increase rate by providing coating. In the case of Comparative Example 1, the NiO layer and the SEI layer increase because those are not coated, and the DC resistance after the cycle increases. As for the initial capacity, the same performance as when coating is not provided is obtained. In addition, Example 1 has the same performance as Comparative Example 24 in the case of washing with water.

In Example 2, the amount of Li is increased as compared with that in Example 1. However, it can be seen that even if the amount of Li is large as above, the performance is the same as in Example 1.

In Example 3, the amount of Ni is made larger than that in Example 1. In this case, the capacity is slightly improved by the effect of the amount of Ni. On the other hand, the cycle characteristics are somewhat inferior to those in Example 1 at no problem level. In Example 4, the amount of Ni is reduced. In this case, the DC resistance is low, and the best result is obtained regarding the cycle characteristics. In Comparative Examples 3 to 6, the composition of the Ni content is small, and the difference in performance depending on the presence or absence of coating of oxide (aluminum oxide) is studied. When the amount of Ni is small, cycle characteristics are excellent even when coating is not performed, and little change is observed even when coating is performed.

In Example 5, the composition of Co or Mn is changed, and the composition is equivalent to that of Example 1 and is excellent.

In Examples 6 to 12, although a part of the composition of Example 1 is replaced with the element B (Al, Ti, Mg, Mo, W, and Zr), excellent results can be obtained in any of them. Particularly, when the element B is Al or Mg, the DC resistance tends to decrease. This is considered to be due to the fact that substitution of an element having a large ionic radius in the layered crystal structure makes it easy for Li ions to inject and extract, and the resistance decreases.

In Examples 13 to 29, the amounts of the oxides (aluminum oxide, magnesium oxide, titanium oxide, zirconium oxide, molybdenum oxide, tungsten oxide) used for coating are changed, and in all cases, when the change amount is within these ranges, excellent results can be obtained. Examples 30 to 35 are the cases where the oxide is coated with the coating method of Chemical A as described above, and the effect is also observed even with this coating method.

Comparative Examples 13 to 22 are the cases where the coating amount is changed, and in the case of Comparative Example 13 in which the coating amount is extremely reduced, the effect on the characteristics due to coating is not observed. On the other hand, in Comparative Examples 14 to 22 in which the coating amount is increased, DC resistance increase and capacity decrease are observed due to the effect of increasing the coating amount.

In FIGS. 3 to 5, the coating amount (wt %) is used as an index representing the coverage.

When the coverage is calculated based on the luminance of the surface of a TEM image and the result of energy dispersive X-ray spectroscopy (EDX) (the average value of the results observed at n=10), the coating amount of 0.1 wt % corresponds to the coverage of 30%, the coating amount of 0.5 wt % corresponds to 50%, and the coating amount of 1 wt % corresponds to 90%.

With this coverage, it can be concluded from the measurement result that “the coverage of the surface of a positive electrode active material is preferably 90% or less and 30% or more in the oxide coating”. When the coverage exceeds 90%, the oxide coating inhibits intercalation of Li ions, and the interfacial resistance increases. In addition, when the coverage is less than 30%, deterioration in cycle characteristics due to an increase in the NiO layer and the SEI coating layer is observed.

In Comparative Example 23, coating is carried out with Chemical B as described above. In this case, since the coverage is increased, and the entire active material is coated, an increase in DC resistance is observed.

Example 36 in which long-term atmospheric storage is performed is somewhat inferior to the case of Example 1 at no problem level. In particular, in comparison with Comparative Example 2 in which long-term atmospheric storage is performed likewise, the performance is significantly lowered in Comparative Example 2 as compared with Example 36 having an oxide coating. Thus, by providing an oxide coating that reacts with HF, even when the amount of LiOH is large, the effect can be obtained.

FIG. 8 indicates measurement results of Comparative Examples 25 to 66 indicated in FIG. 5. In Comparative Examples 25 to 54, the physical coating is replaced from oxide to fluoride in the positive electrode active materials of Examples 1 to 29, and 36, and the difference depending on whether the coating reacts with HF or not is studied.

In the case of Comparative Examples 25 to 54 in which the coating is fluoride, the cycle characteristics are inferior to Examples 1 to 29, and 36 in which the oxide coating is performed. However, in comparison with Comparative Example 1 in which coating is not provided, the characteristics are improved. In Comparative Examples 55, 57, 59, 61, 63 and 65, the amount of fluoride is small, and no effect is observed as with oxides. Further, in Comparative Examples 56, 58, 60, 62, 64, and 66, the amount of fluoride is large. As with the oxides also in this case, the result is that the DC resistance is high.

The reasons why deterioration is suppressed by fluoride coating are as follows: (a) A surface of the positive electrode active material is coated with fluoride, and the area reacting with HF decreases; and (b) It is considered that the reaction of the electrolytic solution and the high Ni-based active material is suppressed by the fluorine capability of fluoride. However, compared to oxide coating reacting with HF, the deterioration suppressing effect is inferior. In the case of using a fluoride, at least one of aluminum fluoride, magnesium fluoride, molybdenum fluoride, tungsten fluoride, titanium fluoride, and zirconium fluoride can be used.

Even when an oxide is used for coating, a fluoride is generated in the coating of the oxide by the reaction of the oxide with HF, for example, “Al₂O₃+HF→2AlF.H₂O”. That is, even when the coating is formed only of oxides at the start of use of a cell, fluoride is generated in the coating with time. Also in that case, since the inhibition effect as described above is also found in the fluoride, the functional deterioration as coating is suppressed. Further, oxide and fluoride may be contained in the coating.

<High Voltage Cycle>

Next, a cell using the positive electrode of Example 1 and a cell using the positive electrode of Comparative Example 1 are prepared, and cycle tests are carried out at high voltage for each cell. In the high-voltage cycle test, constant current and constant voltage charging with a voltage of 4.4 V and a current of 300 mA is performed until the charging current reaches the termination condition of 6 mA, and constant current discharge with a voltage of 3.5 V and a current of 300 mA is performed in discharge. The cycle of charging and discharging is performed for 200 cycles. After 200 cycles, charging is performed at a constant voltage of 3.7 V and a constant current of 300 mA for five hours. Then, discharging is performed for ten seconds at a current of 1 A from a voltage of 3.7 V, and the DC resistance at 200 cycles is calculated from a quotient of a voltage change ΔV and current 1 A at this time. The DC resistance increase rate at 200 cycles is calculated by (initial DC resistance)÷(DC resistance at 200 cycles)×100.

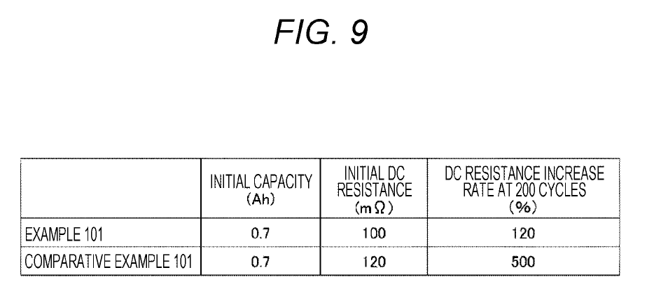

FIG. 9 indicates the results of the high voltage cycle test, Example 101 indicates the results of the high voltage cycle test in the case of Example 1, Comparative Example 101 indicates the results of the high voltage cycle test in the case of Comparative Example 1. Improvement of cycle characteristics at 4.4 V is remarkably improved as compared with the case of 4.2 V. That is, it can be seen that improvement in cycle characteristics due to coating is more effective at high voltage.

According to the above-described embodiments, the following effects can be obtained.

(1) A positive electrode mixture of the positive electrode 5 contains LiOH, LiₐNi_{b}Co_{c}A_{d}BₑO₂ which is a positive electrode active material (a, b, c, d, and e satisfy 1.0≤a≤1.1, 0.45≤b≤0.90, 0.05≤c+d≤0.55, and 0≤e≤0.006, A contains at least one of Mn and Al, and B contains at least one of Al, Mg, Mo, Ti, W and Zr), and an oxide. The oxide contains at least one of aluminum oxide, magnesium oxide, molybdenum oxide, titanium oxide, tungsten oxide, and zirconium oxide.

The oxide contained in the positive electrode mixture reacts with HF derived from LiOH, whereby the formation of the NiO layer and the SEI coating by the reaction between HF and the positive electrode active material is suppressed. As a result, the cycle DCR increase is suppressed, and the cycle characteristics of the secondary cell can be improved.

(2) Further it is preferable that the oxide is provided on the surface of the positive electrode active material. By covering the surface of the positive electrode active material with an oxide, the reaction with HF is hindered, and the formation of the NiO layer and the SEI coating is suppressed, such that the cycle characteristics can be further improved.

In the above-described embodiment, the case of coating one type of oxide has been described. However, two or more types of oxides may be contained in the coating. Both oxides react with HF, such that the formation of NiO layer and SEI coating is suppressed. In the above-described embodiment, the example in which the surface of the positive electrode active material is coated with the oxide is described. However, the oxide or the fluoride may be contained so as to be dispersed in the positive electrode mixture. However, from the viewpoint of suppressing the reaction between the positive electrode active material and HF, the suppressing effect increases when coating is performed.

(3) In addition to the oxide, at least one of aluminum fluoride, magnesium fluoride, molybdenum fluoride, titanium fluoride, tungsten fluoride, and zirconium fluoride may be provided on the surface of the positive electrode active material. Covering with the surface fluoride of the positive electrode active material improves the reaction suppressing effect between the positive electrode active material and HF.

(4) Further, the amount of oxide is preferably 0.1 wt % or more and 1.0 wt % or less with respect to the positive electrode active material. When the coating amount is less than 0.1 wt %, no effect is seen in the cycle characteristics as in Comparative Examples 13, 55, 57, 59, 61, 63, and 65. On the other hand, when the amount exceeds 1.0 wt %, since the coverage is too high, and the entire active material particles are coated, the initial DC resistance increases. Furthermore, since the amount of the positive electrode active material decreases, it also affects reduction of the initial capacity.

(5) Further, the amount of LiOH is preferably 0.5 wt % or more and 2.0 wt % or less with respect to the positive electrode active material. If it is less than 0.5 wt %, the cycle characteristics are already excellent. Therefore, there are concerns about the influence such as increase in initial DC resistance and decrease in initial capacity due to coating. On the other hand, in the situation exceeding 2.0 wt %, it is assumed that the release to the atmosphere is over half a year. However, there is almost no use of such a large amount of LiOH which easily leads to deterioration of cycle performance. Therefore, in consideration of practical use here, the amount of LiOH is set to 2.0 wt % or less.

Although the amount of LiOH after coating tends to decrease, this is because the amount at titration decreases due to the effect of coating, and the actual amount of LiOH is presumed to be the same as before the coating.

Although various embodiments and modifications have been described above, the present invention is not limited to these contents. Other embodiments considered within technical ideas of the present invention are also included within the scope of the present invention.

### REFERENCE SIGNS LIST

1 positive electrode terminal
2 negative electrode terminal
5 positive electrode
6 negative electrode
7 separator
8, 10 laminate film
9 laminated electrode group
11 laminate cell

1. A secondary cell, comprising:
a positive electrode;
a negative electrode; and
an electrolytic solution,
wherein a positive electrode mixture of the positive electrode contains:
LiOH;
LiₐNi_{b}Co_{c}A_{d}BₑO₂ which is a positive electrode active material (a, b, c, d, and e satisfy 1.0≤a≤1.1, 0.45≤b≤0.90, 0.05≤c+d≤0.55, and 0≤e≤0.006, A contains at least one of Mn and Al, and B contains at least one of Al, Mg, Mo, Ti, W and Zr); and
an oxide, and
the oxide contains at least one of aluminum oxide, magnesium oxide, molybdenum oxide, titanium oxide, tungsten oxide, and zirconium oxide.

2. The secondary cell according to claim 1,
wherein the oxide is provided on a surface of the positive electrode active material.

3. The secondary cell according to claim 2,
wherein at least one of aluminum fluoride, magnesium fluoride, molybdenum fluoride, titanium fluoride, tungsten fluoride, and zirconium fluoride is provided on the surface of the positive electrode active material.

4. The secondary cell according to claim 2,
wherein an amount of the oxide is 0.1 wt % or more and 1.0 wt % or less with respect to the positive electrode active material.

5. The secondary cell according to claim 4,
wherein an amount of the LiOH is 0.5 wt % or more and 2.0 wt % or less with respect to the positive electrode active material.

6. The secondary cell according to claim 4,
wherein a coverage of the oxide to the positive electrode active material is 30% or more and 90% or less.
